(19) United States
(12) Patent Application Publication
(10) Pub. No.: US 2018/0139341 A1
(43) Pub. Date: May 17, 2018

(54) IMAGE FORMING APPARATUS CORRESPONDING TO COLORED MEDIA AND IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Eiji Shinohara, Mishima Shizuoka (JP)

(21) Appl. No.: 15/349,077

(22) Filed: Nov. 11, 2016

(51) Int. Cl. H04N 1/00; H04N 1/60

(52) U.S. Cl. CPC H04N 1/00724; H04N 1/00352; H04N 1/00538; H04N 1/00689; H04N 1/00692; H04N 2201/0094; H04N 1/00779; H04N 1/00806; H04N 1/6008; H04N 1/6094; H04N 1/00694

(57) ABSTRACT

An image forming apparatus comprises a reading section, a controller, and an image forming section. The reading section comprises a reading surface and reads a sheet placed on the reading surface. The controller acquires a numerical value indicating a color of a background of the sheet read by the reading section, calculates a correction value on the basis of the numerical value, and applies the correction value to an image to be formed to carry out color correction. The image forming section forms the image to which the color correction is carried out on a sheet having a background in a color identical to the color of the background of the sheet read by the reading section.

### FIELD

Embodiments described herein relate generally to an image forming apparatus which can form an easily recognizable image even if a color of a background of media is a color other than white.

### BACKGROUND

A conventional image forming apparatus forms an image without considering the color of a background of a sheet. Thus, there is a disadvantage in that the visibility of an image formed on a white sheet versus an image formed on a non-white or colored sheet. For example, in a case in which the color of the image formed on the sheet is identical to or similar with the color of the background of the sheet, it is difficult for the eyes to recognize the image (that is, determine where the image finishes and the background begins).

### DESCRIPTION OF THE DRAWINGS

FIG. 1 is a diagram illustrating differences between visibility of a sheet by normal image formation and visibility of a sheet of an embodiment;

FIG. 2 is a schematic diagram illustrating an example of the internal configuration of an image forming apparatus of the embodiment;

FIG. 3 is a block diagram illustrating an example of the configuration of the image forming apparatus of the embodiment;

FIG. 4 is a diagram illustrating an example of display of an operation screen;

FIG. 5 is a diagram illustrating an example of display of a cassette setting screen;

FIG. 6 is a diagram illustrating an example of display of a scan result screen;

FIG. 7 is a flowchart illustrating an example of operations of the image forming apparatus in transition of the screens in FIG. 4˜FIG. 6;

FIG. 8 is a diagram illustrating an example of operations of the image forming apparatus at the time of printing; and

FIG. 9 is a schematic diagram illustrating an example of the internal configuration of an image forming apparatus of another embodiment.

### DETAILED DESCRIPTION

In accordance with an embodiment, an image forming apparatus comprises a reading section, a controller, and an image forming section. The reading section comprises a reading surface and reads a sheet placed on the reading surface. The controller acquires a numerical value indicating a color of a background of the sheet read by the reading section, calculates a correction value on the basis of the numerical value, and applies the correction value to an image to be formed to carry out color correction. The image forming section forms the image to which the color correction is carried out on a sheet having a background in a color identical to the color of the background of the sheet read by the reading section.

Hereinafter, an embodiment is described with reference to the accompanying drawings.

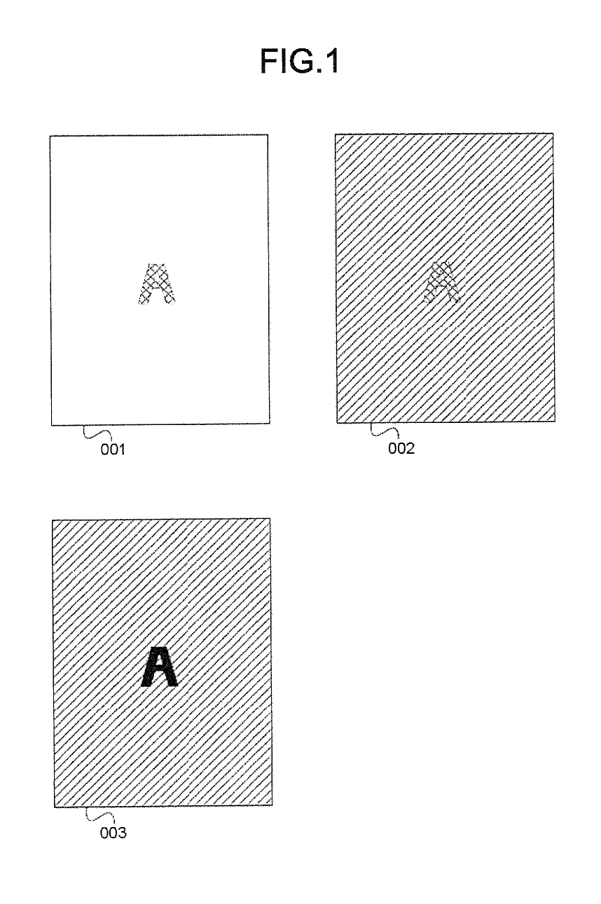

FIG. 1 is a diagram illustrating the present embodiment. In the present embodiment, for the convenience of description, an image formed on a sheet is indicated by a character “A”. Further, in FIG. 1, colors of backgrounds of sheets 002 and 003 are indicated by oblique lines and colors of characters “A” to which color correction is not carried out are indicated by mesh patterns. Hereinafter, it is described that the colors of the sheets 002 and 003 and the characters “A” to which the color correction is not carried out are the same, but these colors are visually identical or similar colors in fact.

A sheet 001 is a printed matter where, for example, a blue image is formed on a white sheet. In this case, as the color of the background of the sheet 001 and the color of the image formation are different, the visibility of the character is normal.

The sheet 002 is a printed matter where, for example, a blue image is formed on a blue sheet. In this case, as the color of the background of the sheet 002 and the color of the image formation are the same, the visibility of the character is poor.

The sheet 003 is a printed matter on which an image to which color correction is carried out through the present embodiment is formed. The sheet 003 is a printed matter where, for example, an image of which the color is changed to dark blue through the color correction is formed on a blue sheet. In this case, as the image of the sheet 003 is printed with the color darker than the color of the background, compared with the sheet 002, the visibility of the character is improved.

In the normal image formation, an image is formed on a white background such as the sheet 001 with a color to such a degree that the color can be recognized by eyes. On the other hand, if the normal image formation is carried out on a colored background, like the sheet 002, there is a case in which the image is buried in the color of the background and is difficult to recognize by eyes. Thus, in the present embodiment, an image forming apparatus is provided which generates a printed matter exemplified in the sheet 003 on which an image is easy to recognize by eyes by carrying out the color correction in response to the color of the background.

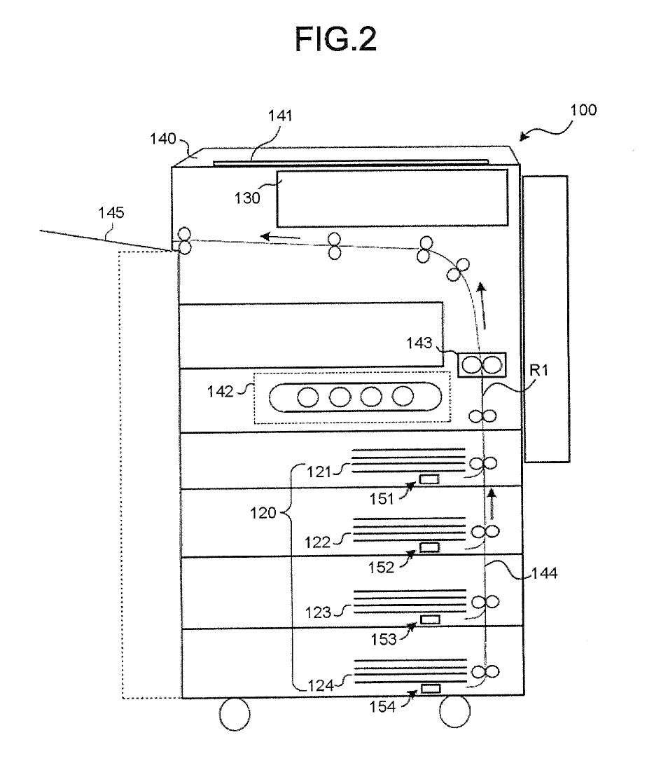

FIG. 2 is a schematic diagram illustrating an example of the internal configuration of the image forming apparatus. Arrows shown in FIG. 2 indicate a conveyance direction of a sheet.

An image forming apparatus 100 stores sheets and includes cassettes 121˜124 for supplying sheets at the time of job execution. The cassettes 121˜124 respectively house new sheets of which colors of backgrounds are different from each other. Sizes or materials of the new sheets may be different in the respective cassettes. The cassettes 121˜124 are set as a sheet feed section 120.

The image forming apparatus 100 includes an image forming section 142 for forming an image on a sheet. The image forming section 142 can carry out both printing with a decolorable color material and printing. with a non-decolorable color material. The image forming section 142 includes a toner bottle housing section for housing/mounting a toner bottle. The toner bottle housing section can house/mount a toner bottle of each color of cyan, magenta, yellow and black.

The image forming apparatus 100 includes a heater 143 for heating and pressuring a sheet to which the image formation is carried out to fix an image on the sheet.

The image forming apparatus 100 includes a conveyance path R1 for conveying a sheet to the sheet feed section 120, the image forming section 142 and the heater 143 in order.

The image forming apparatus 100 includes a touch panel display 130 for receiving an input of a parameter value such as the number of print copies and an instruction of processing start from a user and displaying state of progress of a job and a message.

The image forming apparatus 100 includes a scanner 140. The scanner 140 reads a document sheet arranged on a transparent glass plate 141 serving as a reading surface. The scanner 140 includes a light emitting section and a CCD (Charge-Coupled Device) image sensor and a carrier mechanism for moving the light emitting section and the CCD image sensor. An image read by the scanner 140 is output to the image forming section 142, and the image forming section 142 forms the corresponding image on a sheet (copy processing).

The image forming apparatus 100 includes a sheet discharge tray 145 for receiving a sheet conveyed from the conveyance path R1. The sheet discharge tray 145 may move in a direction substantially vertical to the surface of the conveyed sheet or may not move.

The image forming apparatus 100 includes detection sensors 151˜154 for detecting presence/absence and residual quantity of the sheets in the respective cassettes. The detection sensors 151˜154 are set as a detection section 150.

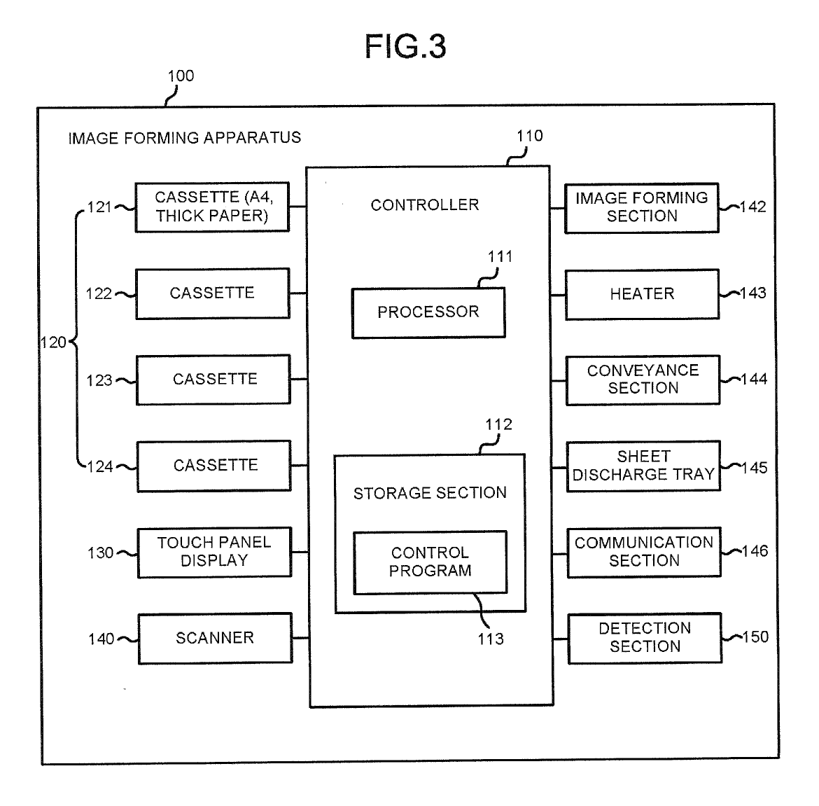

FIG. 3 is a block diagram illustrating an example of the configuration of the image forming apparatus 100. The image forming apparatus 100 includes a controller 110 at least comprising a processor 111 and a storage section 112. The processor 111 is an arithmetic processing apparatus, for example, a CPU (Central Processing Unit). The processor 111 executes a control program 113 stored in the storage section 112 to realize various functions. The storage section 112 includes a main storage device for storing data in a volatile manner or a ROM for storing data in a nonvolatile manner and an auxiliary storage device. The controller 110 collectively controls each unit of the image forming apparatus 100 in such a manner than the processor 111 executes the control program 113 previously stored in the storage section 112. Further, a part or all of the functions provided by the controller 110 may be mounted in a circuit such as an ASIC (Application specific integrated circuit).

The touch panel display 130 includes a flat type liquid crystal screen (display section) and a touch panel (input section). The touch panel display 130 is a configuration in which the touch panel is laminated on the liquid crystal screen, and becomes an inputtable unit by immediately pressing a screen with a fingertip or a pen tip.

A conveyance section 144 includes the conveyance path R1 and conveys a sheet to each unit according to an instruction of the controller 110.

The image forming apparatus 100 includes a communication section 146. The communication section 146 receives a document image from a personal computer on the basis of an instruction of the controller 110 and returns a processing result and the like to a sending source. The image forming apparatus 100 forms the received document image on a sheet.

The cassettes 121˜124 shown in FIG. 3 are stated as above, but in FIG. 3, as to the cassette 121, in parentheses, the size and the material of the housed sheet are recorded. In the present embodiment, the cassette 121 houses thick papers of A4 size, for example. According to the present embodiment, information of the sheets housed in the cassettes can be set in the respective cassettes according to a method described later.

The scanner 140, the image forming section 142, the heater 143, the sheet discharge tray 145 and the detection section 150 are stated as above.

The image forming apparatus 100 includes a copy function, a scan function, a FAX transmission function and a print function. The copy function, the scan function, the FAX transmission function and the print function are basic functions which can be carried out even in the former image forming apparatus. Buttons for using each function are arranged on a home screen displayed on the touch panel display 130, and an operation screen of each function is displayed if a button is pressed by the user.

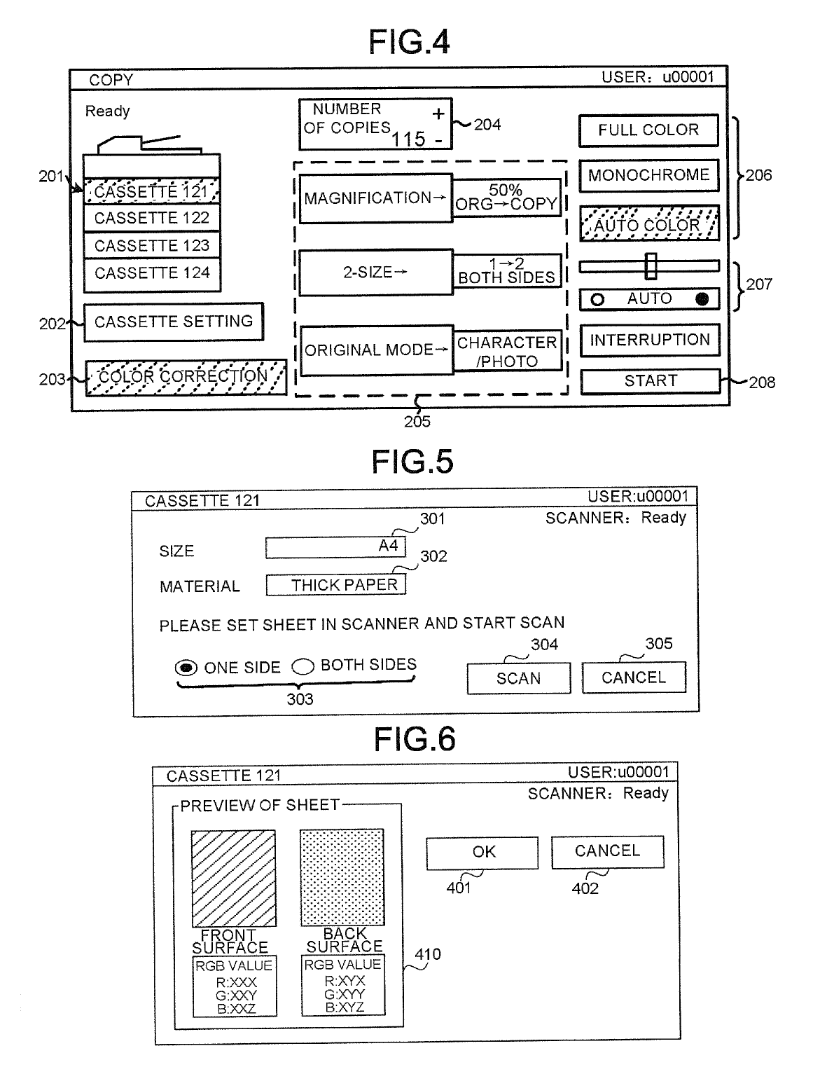

FIG. 4 illustrates an example of an operation screen for carrying out the copy processing of the embodiment, and the screen shown in FIG. 4 is displayed with the button for using the copy function on the foregoing home screen pressed.

The operation screen shown in FIG. 4 is described. An area 201 selects a cassette to which cassette setting described later is applied, and invertedly displays the part of the selected cassette. An area 203 sets whether to adopt color correction at the time the copy processing is carried out on the sheet housed in the cassette selected in the area 201, and is invertedly displayed by selection.

An area 204 sets the number of copies by receiving pressing of “+” button or “−” button and an input from a numeric keypad which is not shown. An area 205 includes 1 or more setting items. In the area 205, for example, various kinds of setting like enlargement/reduction ratio (magnification), allocation setting (one side/both sides) and image quality (character image quality/photo quality) can be carried out. However, the setting items are not limited to these exemplified in FIG. 4. An area 206 sets color/monochrome or automatic recognition of color. An area 207 sets copy density.

If a cassette setting button 202 is pressed in a state in which a cassette is selected in the area 201, the operation screen transits to a cassette setting screen shown in FIG. 5.

If the setting is completed and a start button 208 is pressed, the image forming apparatus 100 carries out the copy processing.

FIG. 5 illustrates the cassette setting screen which is displayed through the pressing of the cassette setting button 202. The cassette setting screen corresponds to the cassette selected in the area 201 shown in FIG. 4, and receives an input of the information of the sheet housed in the cassette. Further, in order to acquire a RGB value by reading the sheet with the scanner 140, the user places the same sheet as the sheet housed in the cassette on the transparent glass plate 141 in advance. In the present embodiment, it is described to input the information of the sheet in the cassette 121 which is invertedly displayed in FIG. 4.

Areas 301 and 302 respectively receive the information relating to the size and the material of the housed sheet. Both areas respectively include specific values of the size and the material of the sheet, and may receive the input through selection of the user. A selection column 303 is used to select whether to acquire the RGB value of the sheet from only one side or the RGB values from both sides. The selection column 303 can only select one of one side and both sides.

The information input to the area 301, the area 302 and the selection column 303 is set as first information. In other words, the first information in the present embodiment includes information of “A4” of the area 301, “thick paper” of the area 302 and “both sides” of the selection column 303.

After a scan button 304 is pressed, the image forming apparatus 100 carries out scan of the sheet set in the scanner 140 by the user in advance. Further, after the scan button 304 is pressed, a screen for confirming whether or not the scan is started may be displayed.

In the case of selecting “both sides” on the selection column 303, the touch panel display 130 displays a message indicating that the scan of a first side is carried out before the scan is started, and displays a button for receiving a signal of the start of the scan. After the scan of the first side is ended, the touch panel display 130 displays a message indicating that the scan of a second side is carried out, and displays the button for receiving the signal of the start of the scan.

If a cancel button 305 is pressed, the screen cassette setting returns to the operation screen shown in FIG. 4.

FIG. 6 illustrates a scan result screen displayed after the end of the scan.

An area 410 displays images of the sheet read through the scan. Further, the area 410 displays the RGB values of the sheet in association with the images of the sheet. FIG. 6 illustrates an example of displaying the RGB values of the images of the front surface and the back surface.

If an OK button 401 is pressed, the controller 110 calculates a correction value for carrying out the color correction on the formed image from the RGB value. After that, the first information and the correction value are associated with the cassette 121 and stored, and then the scan result screen returns to the operation screen shown in FIG. 4.

If a cancel button 402 is pressed, the scan result screen returns to the cassette setting screen shown in FIG. 5 without carrying out the calculation of the correction value. Further, with the pressing of the cancel button 402, the scan may be redone or the scan result screen may return to the operation screen shown in FIG. 4.

After the OK button 401 is pressed, if the scan result screen returns to the operation screen shown in FIG. 4, preparation for applying the color correction is completed. In this state, if the area 203 is invertedly displayed like FIG. 4, and the start button 208 is pressed, the copy processing to which the color correction is applied is carried out. Hereafter, at the time of executing a job of forming an image, if the area 203 is selected, the image formation is carried out with the correction value. Further, as the cassette to which the setting is completed is selected again in the area 201, and the cassette setting button 202 is pressed, the foregoing setting can be reset.

In this way, the controller 110 determines whether to apply the correction value to the image formation according to information indicating whether or not the color correction is carried out which is received by the input section (touch panel) of the touch panel display 130 (in the present embodiment, according to whether or not the area 203 is pressed).

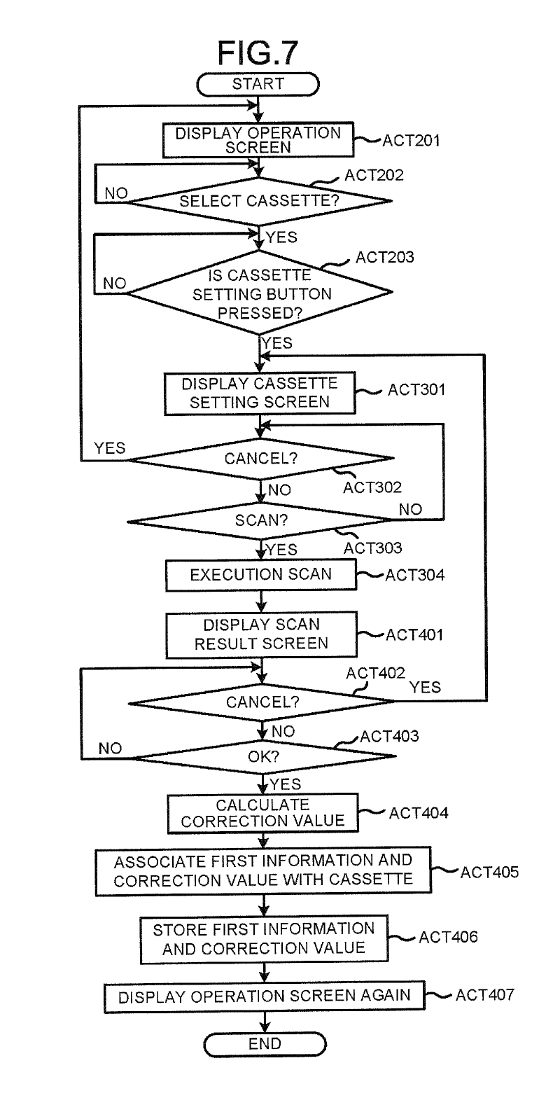

FIG. 7 is a flowchart illustrating an example of operations at the time of associating the correction value with the cassette. The flow in FIG. 7 is realized in such a manner that the processor 111 executes the control program 113.

The user carries out predetermined operations for carrying out the copy processing on the touch panel display 130. The processor 111 executes the following operations according to the predetermined operations.

The operation screen shown in FIG. 4 is displayed on the touch panel display 130 through the operation of the user (ACT 201). The processor 111 determines whether or not the cassette in the area 201 is selected (ACT 202). If the cassette is not selected, the operation screen keeps an input reception state (loop of No in ACT 202).

If the cassette is selected (Yes in ACT 202), the processor 111 determines whether or not the cassette setting button 202 is pressed (ACT 203). If the cassette setting button 202 is not pressed, the operation screen keeps the input reception state (loop of No in ACT 203). If the cassette setting button 202 is pressed (Yes in ACT 203), the operation screen transits to the cassette setting screen shown in FIG. 5 (ACT 301).

The cassette setting screen receives the input of the first information. The processor 111 determines whether or not the cancel button 305 is pressed (ACT 302). If the cancel button 305 is pressed (Yes in ACT 302), the processing returns to ACT 201, and transits to the operation screen shown in FIG. 4.

If the cancel button 305 is not pressed (No in ACT 302), the processor 111 determines whether or not the scan button 304 is pressed (ACT 303).

If the scan button 304 is not pressed (No in ACT 303), the processing returns to ACT 302, and keeps the input reception state.

After the user places a sheet serving as an object on the transparent glass plate 141, if the scan button 304 is pressed (Yes in ACT 303), the processor 111 executes the scan (ACT 304), and reads the sheet placed on the transparent glass plate 141. In the case of the setting of the scan of. both sides of the sheet, a screen for notifying the user of a message of carrying out the scan of the first side and the scan of the second side in order may be displayed.

If the scan is completed, the scan result screen shown in FIG. 6 is displayed (ACT 401). The user can confirm the image of the sheet and the RGB value acquired from the sheet on the scan result screen. In a case in which variation is generated in the RGB value according to an image pixel, an average value may be calculated and displayed.

The processor 111 determines whether or not the cancel button 402 is pressed (ACT 402). If the cancel button 402 is pressed (Yes in ACT 402), the processing returns to ACT 301, and transits to the cassette setting screen shown in FIG. 5.

If the cancel button 402 is not pressed (No in ACT 402), the processor 111 determines whether or not the OK button 401 is pressed (ACT 403). If the OK button 401 is not pressed (No in ACT 403), the processing returns to ACT 402, and keeps the scan result screen.

If the OK button 401 is pressed (Yes in ACT 403), the processor 111 calculates the correction value for carrying out the color correction on the basis of the RGB value (ACT 404).

The correction value is calculated by deducting the RGB value of the sheet serving as the object from the RGB value (R: 255, G: 255 and B: 255) as reference of the sheet of which the background is white. For example, in a case in which the RGB value of the sheet serving as the object is R: 219, G: 225 and B: 232, the correction value is R: 36, G: 30 and B: 23. By applying the calculated correction value with a method described later, the correction is carried out so that the final toner output becomes dark. An implementation example may be described as follows: a RGB color space is converted to an HSV color space, brightness of corresponding color tone is decreased or adjustment of increasing or decreasing chroma is carried out, and the HSV color space returns to the RGB color space. In this case, the decrease value of the brightness or the adjustment value of the chroma is the correction value. The implementation example is merely an example.

The processor 111 associates the first information and the correction value with the cassette (ACT 405), and stores the first information and the correction value in the storage section 112 (ACT 406). After that, the operation screen (FIG. 4) is displayed again (ACT 407).

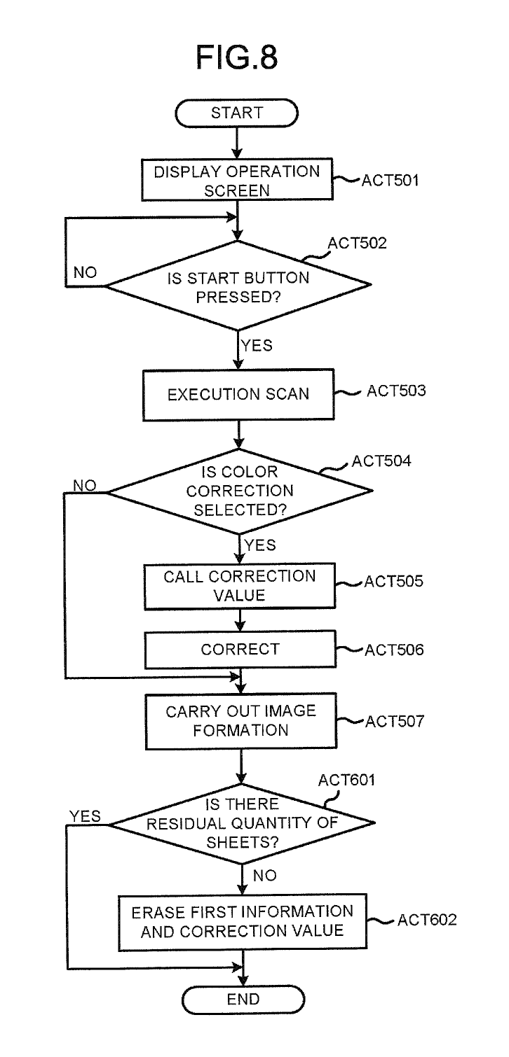

FIG. 8 is a flowchart illustrating an example of operations of the image forming apparatus at the time of the copy processing. The flow in FIG. 8 is realized in such a manner that the processor 111 executes the control program 113. The user places the document sheet on the transparent glass plate 141 or an ADF (Auto document feeder) (not shown) in advance.

The operation screen shown in FIG. 4 is displayed on the touch panel display 130 through the operation of the user (ACT 501). Herein, the cassette in the area 201 is selected by the user. The information of the areas 204-207 is input by the user.

The processor 111 determines whether or not the start button 208 is pressed (ACT 502). If the start button 208 is not pressed, the operation screen keeps the input reception state (loop of No in ACT 502).

If the start button 208 is pressed (Yes in ACT 502), the processor 111 executes the scan (ACT 503).

After the scan is ended, the processor 111 determines whether or not the color correction button 203 is selected on the operation screen in advance (ACT 504).

If the color correction button 203 is selected (Yes in ACT 504), the processor 111 calls the correction value associated with the cassette from the storage section 112 (ACT 505). The processor 111 corrects the image of the document sheet obtained by the scan on the basis of the correction value (ACT 506).

The correction is carried out by deducting the correction value from the RGB value of the document image. For example, in a case in which the RGB value of one image pixel of the document image is R: 200, G: 211 and B: 246, the foregoing correction value (R: 36, G: 30 and B: 23) is deducted from the RGB value, and the corrected RGB value of the image pixel is R: 164, G: 181 and B: 223. The processor 111 carries out the correction processing on all image pixels of the document image. Further, in a case in which the RGB value of the image pixel acquired as a processing object is white or almost white (R: 255, G: 255 and B: 255, or a value approximate to R: 255, G: 255 and B: 255), the image pixel is regarded as being located at the background area of the document image, and this RGB value of the document image may be adopted without carrying out the correction on the image pixel.

After that, the processor 111 carries out the image formation to which the correction value is applied (ACT 507), and generates a printed matter.

If the color correction button 203 is not selected (No in ACT 504), the image formation is carried out without correcting the image of the document sheet (ACT 507).

After the image formation is carried out, the processor 111 determines whether or not a sheet remains in the cassette through the detection section 150 (ACT 601). If the sheet remains (Yes in ACT 601), the processor 111 ends the operation. If the sheet does not remain (No in ACT 601), the processor 111 erases the first information and the correction value associated with the cassette (ACT 602), and ends the operation. Further, if the sheet does not remain, a screen for instructing supplement of sheets may be displayed on the touch panel display 130.

In the foregoing embodiment, the correction value is associated with the cassette and stored; however, instead of the correction value, the RGB value of the sheet may be associated with the cassette. In this case, at the time of carrying out the job of the image formation, the correction value is calculated on the basis of the RGB value associated with the cassette each time, and the correction value is applied to the document image.

In the foregoing embodiment, if the OK button 401 is pressed by the user (Yes in ACT 403), the correction value is calculated (ACT 404), and the correction value may be calculated before the processing in ACT 505.

Further, the RGB value may be properly converted to a CMYK value through the, former method.

In the foregoing embodiment, the implementation of the copy processing is described mainly; however, a print processing may be implemented. For example, the communication section 146 receives an image sent from a computer, and the processor 111 corrects the color of the image to generate a printed matter.

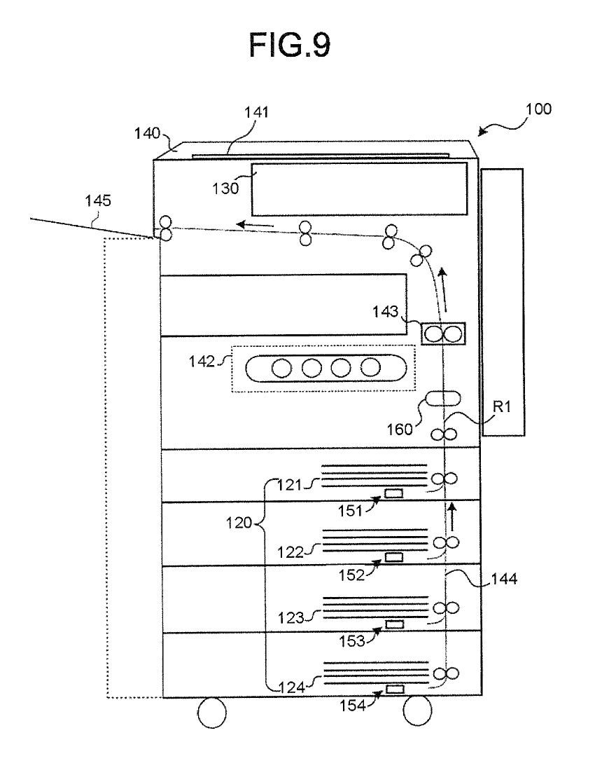

Further, in another embodiment, a RGB value of a sheet may be acquired by a camera arranged in an image forming apparatus. For example, as shown in FIG. 9, after passing through a camera 160 by the conveyance section 144, a sheet further passes through the image forming section 142. According to the embodiment, even if the information of the RGB value and the correction value is not associated with the cassette in advance, the color correction can be carried out in real time at the time of the execution of the image formation. Specifically, the RGB value of the background of the sheet conveyed from the cassettes 121˜124 is acquired by the camera 160, and the processor 111 calculates a correction value and applies the correction value to the document image to form an image on the sheet with the image forming section 142.

According to the embodiment, even if an image is formed on a sheet including a color in a background, a printed matter on which contents are easy to recognize by eyes can be generated.

A case in which functions for executing the prevention are pre-recorded inside the apparatus is described in the present embodiment; however, the present invention is not limited to this, and the same functions may be downloaded in the apparatus from a network, and a device for storing the same functions in a recoding medium may be installed in the apparatus. The form of the recoding medium may be any form as long as the recoding medium may be a recoding medium such as a CO-ROM which can store a program and can be read by the apparatus. Further, the functions obtained by previous installation or downloading in this way may cooperate with an OS (operating system) inside the apparatus to realize the functions.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a reading section comprising a reading surface and configured to read a sheet placed on the reading surface;
a controller configured to acquire a numerical value indicating a color of a background of the sheet read by the reading section, calculate a correction value on the basis of the numerical value, and apply the correction value to an image to be formed to carry out color correction; and
an image forming section configured to form the image to which the color correction is carried out on a sheet having a background in a color identical to the color of the background of the sheet read by the reading section.

2. The image forming apparatus according to claim 1, further comprising:
a cassette configured to house the sheet read by the reading section or the sheet having the background in the color identical to the color of the sheet read by the reading section; and
a storage section configured to store both or one of the numerical value indicating the color of the background and the correction value in association with the cassette.

3. The image forming apparatus according to claim 2, further comprising:
a detection section configured to detect presence/absence of the sheet read by the reading section or the sheet having the background in the color identical to the color of the sheet read by the reading section, which is housed in the cassette.

4. The image forming apparatus according to claim 3, wherein
the controller erases both or one of the numerical value indicating the color of the background and the correction value associated with the cassette in a case in which there is no sheet read by the reading section or no sheet having the background in the color identical to the color of the sheet read by the reading section in the cassette.

5. The image forming apparatus according to claim 1, further comprising:
an input section configured to receive an input of a user, wherein
the controller determines whether to apply the correction value to image formation according to information which is received by the input section and indicates whether to carry out the color correction.

6. The image forming apparatus according to claim 1, wherein the numerical value is an RGB value.

7. The image forming apparatus according to claim 1, wherein the numerical value is a CMYK value.

8. An image forming apparatus, comprising:
a recognition section configured to recognize a color of a background of a passing sheet;
a controller configured to acquire a numerical value indicating the color of the background of the sheet recognized by the recognition section, calculate a correction value on the basis of the numerical value, and apply the correction value to an image to carry out color correction;
an image forming section configured to form the image to which the color correction is carried out on a sheet having a background in a color identical to the color of the background of the recognized sheet; and
a conveyance section configured to convey the sheet to the recognition section and the image forming section in order.

9. The image forming apparatus according to claim 8, wherein the numerical value is an RGB value.

10. The image forming apparatus according to claim 8, wherein the numerical value is a CMYK value.

11. An image forming method of an image forming apparatus, comprising:
reading a sheet placed on a reading surface;
acquiring a numerical value indicating a color of a background of the read sheet, calculating a correction value on the basis of the numerical value, and applying the correction value to an image to carry out color correction; and
forming the image to which the color correction is carried out on a sheet having a background in a color identical to the color of the background of the read sheet.

12. The image forming method according to claim 11, further comprising:
storing both or one of the numerical value indicating the color of the background and the correction value in association with a cassette which houses the read sheet or the sheet having the background in the color identical to the color of the read sheet.

13. The image forming method according to claim 12, further comprising:
detecting presence/absence of the read sheet or the sheet having the background in the color identical to the color of the read sheet, which is housed in the cassette.

14. The image forming method according to claim 13, further comprising:
erasing both or one of the numerical value indicating the color of the background and the correction value associated with the cassette in a case in which there is no read sheet or no sheet having the background in the color identical to the color of the read sheet in the cassette.

15. The image forming method according to claim 11, wherein the numerical value is an RGB value.

16. The image forming method according to claim 11, wherein the numerical value is a CMYK value.
